(19) United States
(12) Patent Application Publication
(10) Pub. No.: US 2020/0089638 A1
(43) Pub. Date: Mar. 19, 2020

(54) Network Connection Apparatus and Method

(71) Applicant: John Young, Goleta, CA (US)

(72) Inventor: John Young, Goleta, CA (US)

(21) Appl. No.: 16/573,338

(22) Filed: Sep. 17, 2019

Related U.S. Application Data
(60) Provisional application No. 62/733,167, filed on Sep. 19, 2018.

(51) Int. Cl. G06F 13/38; H04W 76/14; H04W 88/06

(52) U.S. Cl. CPC G06F 13/385; H04W 76/14; H04W 84/12; G06F 2213/3814; H04W 88/06

(57) ABSTRACT

A network connection apparatus and a method of connecting to a network using the apparatus. The apparatus includes a housing having a body and a cap. The body has a hole located at one end and a USB port protrudes therethrough. There is a light attached to the body. The light is configured to illuminate when the apparatus connects to a network. The apparatus contains a logic on a memory located within the housing. The logic contains rules to allow the apparatus to search for various networks. The apparatus primarily searches for mobile networks. Once a network is located the apparatus determines if a connection can be made. The apparatus will then connect to a network.

### CROSS REFERENCE TO RELATED APPLICATIONS

This application claims the benefit of U.S. Provisional Application No. 62/733,167 filed on Sep. 19, 2018. The above identified patent application is herein incorporated by reference in its entirety to provide continuity of disclosure.

### BACKGROUND OF THE INVENTION

The present invention relates to a network connection apparatus and method. More particularly, the present invention provides a solution to allow an individual to connect a device to a mobile LTE network or a WIFI connection, utilizing the apparatus, when the device itself does not have wireless network capabilities.

Many people have appliances that have features only useable if connected to a network. Many times, these features are not necessary to the devices' main feature. For example, modern refrigerators or other devices can have many different capabilities that require a network. These appliances can for example, show the weather or a newspaper front page. These features are not necessary to the device's functionality. Therefore, it may cost extra to have a network connection built into the appliance. Further, many tablets and computers or other future technology can benefit from having network capabilities.

Further, many older devices may not have a network adaptor. In today's society many people are constantly on the go. This may complicate the ability to use a device. Many tablets and computers do not have a mobile network connector built in. It can be costly to get a mobile hotspot or to add a network adaptor to the device. Further, even if a mobile hotspot is an option the device still may not have a network adaptor.

Consequently, there is a need in for an improvement in the art of network connection. The present invention substantially diverges in design elements from the known art while at the same time solves a problem many people face in using devices with no network connection capabilities. In this regard the present invention substantially fulfills these needs.

### SUMMARY OF INVENTION

The present invention provides a network connection apparatus and method for providing convenience to a user when using a device that may not otherwise have one or more network connection capabilities. The present apparatus comprises a housing having a body and an end cap. The body has an opening at one end, the opening allows for male USB port to protrude therefrom. The cap is configured to connect to the body covering the male USB port. A memory and a wireless transceiver are operably coupled to the USB port, wherein the memory and the wireless transceiver are located inside of the body. A logic stored on the memory is configured to enable the apparatus to connect the device to a mobile network.

Another object of the present invention is to provide an antenna to ensure a long range network adaptor that will allow an individual to connect to a network over longer distances.

Another object of the present invention is to provide a network adaptor that will allow a device with no built-in network adaptor to be able to connect to a WIFI network.

Another object of the present invention is to provide a network connection to an LTE network without the need for a mobile hot spot.

Another object of the present invention is to provide a method for generating a network connection. The method comprises delivering electricity to the network connection apparatus from a device or appliance, searching for at least one mobile network, determining if a connection can be made to the at least one mobile network, and connecting to the at least one mobile network.

Another object of the present invention is to provide a method for connecting to a network that also searches for and connects to a WIFI network.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood alters review of the following description, taken in connection with the accompanying drawings wherein like numeral annotations are provided throughout.

FIG. 1 shows a perspective view of an embodiment of the network connection apparatus.

FIG. 2 shows a perspective view of an embodiment of the network connection apparatus with an antenna operably attached thereto.

FIG. 3 shows a diagram of an embodiment of a plurality of connections of the network connection apparatus.

FIG. 4 shows a flow chart of an embodiment of a method of connecting to a network.

### DETAILED DESCRIPTION OF THE INVENTION

Reference is made herein to the attached drawings. Like reference numerals are used throughout the drawings to depict like or similar elements of the network connection apparatus and method. For the purposes of presenting a brief and clear description of the present invention, the preferred embodiment will be discussed as used for connecting to the best possible network available using a device in combination with an apparatus of the present invention. The figures are intended for representative purposes only and should not be considered to be limiting in any respect.

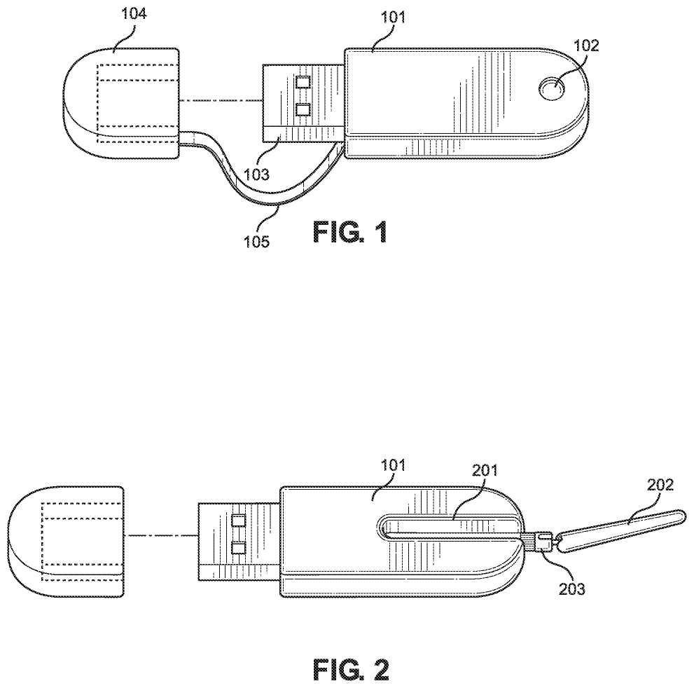

Referring now to FIG. 1, there is shown a perspective view of an embodiment of the network connection apparatus and an end cap. The network connection apparatus has a housing made up of a body 101 and a cap 104. The body 101 has a bottom and a top portion and at least one side wall defining an interior volume. In one embodiment the body 101 has beveled edges. In one embodiment the body 101 has a rounding end portion. In one embodiment the body 101 is plastic. In one embodiment the body 101 is metal. The body 101 has a hole at one end. This hole is configured to receive a universal serial bus (USB) port 103, such as a male USB port, therethrough. In one embodiment the USB port 103 is a micro USB port. In one embodiment the USB port 103 is a USB C port.

In one embodiment the body has a hole located therethrough on the top portion. This hole has a light 102 placed therein. In one embodiment the light 102 is green. In one embodiment the light 102 is red. In one embodiment the light 102 is yellow. In one embodiment the light 102 is a light emitting diode (LED) light. In one embodiment the light 102 is a color changing LED.

In one embodiment a cap 104 is provided. In one embodiment the cap 104 is square. In one embodiment the cap 104 has beveled edges. In one embodiment the cap 104 is attached to the body with a cord 105 so that it is tethered when removed from the body 101. The cap 104 is configured to accept the male USB port 103 therein. The cap 104 is further configured to removably secure to the body. In one embodiment the cap 104 secures to the body via a friction fit. In one embodiment the cap 104 secures to the body via a snap. In one embodiment the cap 104 is configured to frictionally connect to the USB port 103.

FIG. 2 shows a perspective view of an embodiment of the network connection apparatus with an antenna attached. In one embodiment the body 101 has an antenna 202 protruding therefrom. In one embodiment the antenna 202 protrudes from an end opposite the USB port. In one embodiment the antenna 202 protrudes from a sidewall of the body. In one embodiment the antenna 202 is connected to the body 101 with a hinge 203. In one embodiment the antenna 202 is a two-part antenna. In this embodiment a first part of the antenna 202 protrudes from the body. A hinge 203 is then disposed on the antenna 202 to allow the antenna to bend. In one embodiment the antenna 202 is flexible, and no hinge is required. In one embodiment the antenna 202 can swivel.

In the shown embodiment there is a channel 201 located in the body, in one embodiment the channel 201 is disposed on the top portion of the body 101. In one embodiment the channel 201 is disposed on the bottom portion of the body 101, wherein the bottom portion is opposite the top portion. In one embodiment the channel 201 is disposed on a sidewall of the body 101. The channel 201 is configured to house the antenna 202 when the antenna 202 is in a folded state. In one embodiment the channel 201 is configured to snugly fit the antenna 202. In another embodiment there are sections in the channel 203 to allow the antenna 202 to be pulled therefrom.

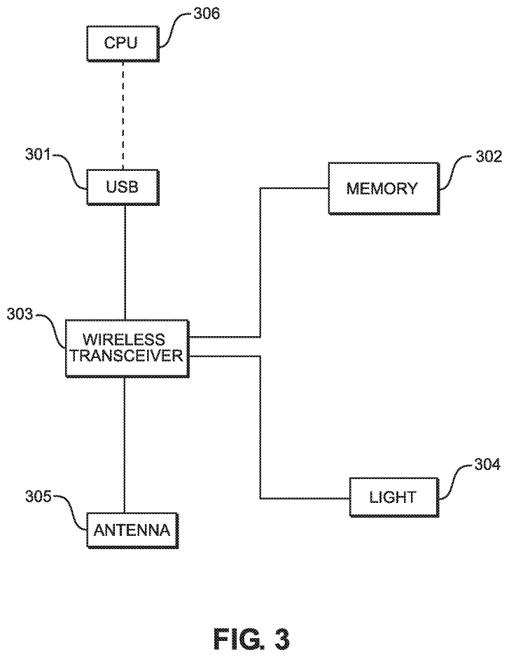

Referring now to FIG. 3, there is shown a diagram of an embodiment of the connections of the network connection apparatus. The apparatus has components located within the body. The components are the USB connection 301, a wireless transceiver 303, a memory 302, an antenna connection 305, and a light connection 304. In one embodiment the wireless transceiver 303 is connected to the USB connection 301. In one embodiment the memory 302 is connected to the USB connection 301. The memory 302 has a logic stored thereon. In one embodiment the light connection 304 is connected to the USB port 301. In one embodiment the antenna 305 is connected to the wireless transceiver 303.

In one embodiment the USB connection 301 is connected to a CPU 306. In this embodiment the machine with the CPU provides a power source. In another embodiment the device is built into a device. In this embodiment the device will no longer require a housing and the circuitry can be placed directly into a device. This will give the device the ability to connect both to WIFI or a LTE. In this embodiment a user may selectively switch between the cellular network and WI-FI network on their electronic device without having to removably secure a housing thereto.

In one embodiment the CPU takes the logic from the memory and runs the logic. In this embodiment the CPU controls the components. In one embodiment the logic contains instructions for how the light is supposed to operate. In some embodiments the logic contains instructions on how the wireless transceiver is supposed to select networks. In an embodiment where the logic contains instructions for how to select networks the logic may further contain constructions to override any original wireless circuitry. These instructions will allow the device to be the primary wireless connection device. In one embodiment the logic contains instructions for how the apparatus is supposed to search for networks.

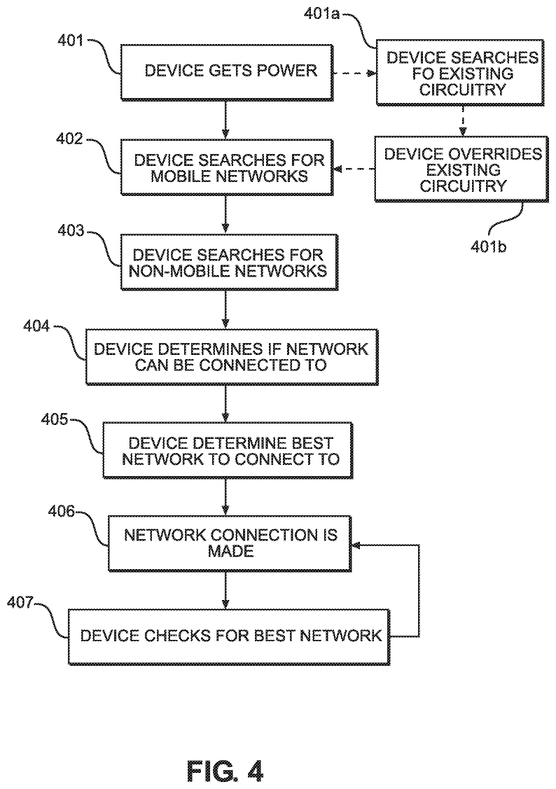

Referring now to FIG. 4, there is shown a flow chart of an embodiment of a method of connecting to a network. In the shown embodiment the apparatus gets power 401 from the machine housing the CPU via the USB port, then downloads the logic from the memory of the apparatus. The CPU of the device will then instruct the apparatus to begin searching for mobile networks 402. A mobile network may include a cellular network. In one embodiment the mobile network is 3G LTE. In one embodiment the mobile network is 4G LTE. In one embodiment the mobile network is 5G LTE.

In an alternative embodiment the apparatus gets power 401 from the machine housing the CPU via the USB port, then downloads the logic from the memory of the apparatus. The logic will instruct the CPU to search for any pre-existing wireless connection devices 401a. In one embodiment the logic will also search for wired network connections. If no pre-existing wireless connection devices are found, then the logic will proceed to searching for networks 402. If pre-existing wireless connection devices are found the logic may then proceed to de-activate the pre-existing connection devices 401b. This will ensure that the device is the sole connection device and prevent unexpected network switching. After the pre-existing wirelss connection devices are disabled the logic will proceed to searching for networks 402.

In one embodiment the CPU instructs the apparatus, based on the logic to connect to the mobile network. In one embodiment the CPU instructs the apparatus to search for non-mobile networks 403. In one embodiment a non-mobile network is WI-FI. In one embodiment a non-mobile network is a Bluetooth network.

In one embodiment the CPU lists the available networks that have been found. In this embodiment the CPU then determines which networks can be connected to 404. In one embodiment no networks will be able to be connected to. In this embodiment the CPU will instruct the apparatus to search again.

In one embodiment the CPU uses the list of networks that can be connected to and chooses the best network to connect to 405. At this point the connection is made to the chosen network 406. The device will periodically scan for better networks 407 and repeat the process to ensure that the best network is connected to.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A network connection apparatus, comprising:
a housing having a body and a cap;
wherein The body has an opening at one end, the opening includes a male USB port protruding therefrom;
wherein The cap is configured to connect to the body to cover the male USB port;
wherein A memory and a wireless transceiver are operably coupled to the USB port, wherein the memory and the wireless transceiver are located inside of the body;
wherein A logic is configured to allow the apparatus to connect to a network.

2) The network connection apparatus of claim 1, further comprising an antenna operably coupled to the wireless transceiver.

3) The network connection apparatus of claim 2, wherein the antenna is located on an outside of the body.

4) The network connection apparatus of claim 1, wherein the logic allows the apparatus to connect to a WIFI network.

5) The network connection apparatus of claim 1, wherein a mobile network is a 4G LTE network.

6) The network connection apparatus of claim 4, wherein the logic selects a best connection.

7) A method for network connection, comprising:
receiving power to the network connection apparatus from a device;
searching for at least one mobile network;
determining if a connection can be made to the at least one mobile network;
connecting to the at least one mobile network.

8) The method for a network connection of claim 7 wherein the at least one network is a 4G LTE network.

9) The method for a network connection of claim 7, further comprising searching for additional non-mobile networks.

10) The method for a network connection of claim 9, further comprising determining if a connection can be made to the additional non mobile networks.

11) The method for a network connection of claim 10, further comprising determining which of the at least one mobile network and additional non-mobile networks have a best connection.

12) The method for a network connection of claim 11, further comprising connecting to a best network.

13) The method for a network connection of claim 7, further comprising selecting a mobile network to connect to where it is determined a connection can be made.
